(19) United States
(12) Patent Application Publication
(10) Pub. No.: US 2019/0088224 A1
(43) Pub. Date: Mar. 21, 2019

(54) LIQUID CRYSTAL DISPLAY DEVICE

(71) Applicant: SHARP KABUSHIKI KAISHA, Sakai City (JP)

(72) Inventors: HIDEKI FUJIMOTO, Sakai City (JP); MAKOTO KITAGAWA, Sakai City (JP); YUSUKE NISHIHARA, Sakai City (JP); YOSHITO HASHIMOTO, Sakai City (JP)

(21) Appl. No.: 16/134,843

(22) Filed: Sep. 18, 2018

(30) Foreign Application Priority Data
Sep. 20, 2017 (JP) 2017-179766

(51) Int. Cl. G09G 3/36

(52) U.S. Cl. CPC G09G 3/3655; G09G 2310/066; G09G 2320/0247; G09G 3/3614

(57) ABSTRACT

Common electrodes are provided in a manner in which the common electrodes are divided into a common electrode for an odd column corresponding to a pixel electrode to which a positive video signal is applied in a certain frame period, and a common electrode for an even column corresponding to a pixel electrode to which a negative video signal is applied in the certain frame period. A common electrode driver is configured to be capable of separately applying a voltage to the common electrode for the odd column and the common electrode for the even column.

### BACKGROUND OF THE INVENTION

### 1. Field of the Invention

The present disclosure relates to a liquid crystal display device, and more particularly, to a liquid crystal display device employing low-frequency driving.

### 2. Description of Related Art

In recent years, there is an increasing demand for reduction in power consumption with regard to liquid crystal display devices. A conventional liquid crystal display device is generally driven at a driving frequency (frame frequency) of 60 Hz, but because the higher the driving frequency, the more increased power consumption is, technology for reducing the driving frequency to achieve lower power consumption is being actively developed. A typical example is “low-frequency driving”, which enables switching between a pause period during which the driving frequency is significantly reduced and a normal period during which the driving frequency is higher than in the pause period. With the low-frequency driving, the driving frequency in the normal period is 30 Hz, and the driving frequency in the pause period is 1 Hz, for example. When there is no change on a display screen for a predetermined period of time, the normal period is switched to the pause period, and when an operation is performed by a user or data is transmitted from outside, the pause period is switched to the normal period.

However, in a liquid crystal display device employing such low-frequency driving, a flicker is possibly caused due to a frequency component at half the driving frequency being generated with respect to a change in brightness. For example, when the liquid crystal display device is driven at a driving frequency of 30 Hz, a frequency component at 15 Hz is generated with respect to a change in brightness, and the change in brightness appears as a flicker to a human eye. Generation of such a flicker will be described below in detail. It should be noted that, in the following, a description is given citing as an example a case where a liquid crystal display device employing a column-reversal driving of reversing a polarity of a liquid crystal applied voltage on a per-column basis is driven at a driving frequency of 30 Hz.

FIG. 14 is a signal waveform diagram for describing a state where ideal display is performed. In FIG. 14, a change in a video signal voltage V(o) in an odd column, and a change in a video signal voltage V(e) in an even column are shown by solid lines, and a voltage Vcom applied to a common electrode (hereinafter referred to as “common voltage”) is shown by a dotted line. A video signal is given to a pixel electrode through a TFT provided near an intersecting part of a gate bus line and a source bus line, and thus, a difference between the video signal voltage V(o) and the common voltage Vcom is the liquid crystal applied voltage in an odd column, and a difference between the video signal voltage V(e) and the common voltage Vcom is the liquid crystal applied voltage in an even column.

In the example shown in FIG. 14, an optimum common electrode voltage (common voltage at which brightness when the liquid crystal applied voltage has a positive polarity and brightness when the liquid crystal applied voltage has a negative polarity are the same; also referred to as “optimum Vcom”) is the same between an odd column and an even column. In other words, a value of the optimum common electrode voltage and a value of the common voltage Vcom are the same for both the odd column and the even column. Accordingly, as shown in FIG. 14, in the odd frame FR(o), “difference 91a between the video signal voltage V(o) and the optimum common electrode voltage in the odd column” and “difference 91d between the video signal voltage V(e) and the optimum common electrode voltage in the even column” are the same, and in the even frame FR(e), “difference 91b between the video signal voltage V(o) and the optimum common electrode voltage in the odd column” and “difference 91c between the video signal voltage V(e) and the optimum common electrode voltage in the even column” are the same. As a result, a waveform as shown in FIG. 15 is obtained with respect to a change in brightness. In this case, brightness is changed at a frequency of 30 Hz.

FIG. 16 is a signal waveform diagram for describing a state where a flicker is generated. It should be noted that, in FIG. 16, the optimum common electrode voltage in an even column is indicated by a solid line denoted by a reference sign 92. In the example shown in FIG. 16, the value of the optimum common electrode voltage is different between an odd column and an even column. More specifically, in the odd column, the value of the optimum common electrode voltage is the same as the value of the common voltage Vcom, but in the even column, the value of the optimum common electrode voltage is different from the value of the common voltage Vcom. Accordingly, as shown in FIG. 16, in the odd frame FR(o), “difference 93d between the video signal voltage V(e) and the optimum common electrode voltage in the even column” is smaller than “difference 93a between the video signal voltage V(o) and the optimum common electrode voltage in the odd column”, and in the even frame FR(e), “difference 93c between the video signal voltage V(e) and the optimum common electrode voltage in the even column” is greater than “difference 93b between the video signal voltage V(o) and the optimum common electrode voltage in the odd column”. As a result, a waveform as shown in FIG. 17 is obtained with respect to a change in brightness. In this case, brightness is changed at a frequency of 15 Hz.

Generally, when a frequency component of 5 Hz to 15 Hz is generated with respect to a change in brightness, the change in brightness appears as a flicker to a human eye. Accordingly, when a waveform as shown in FIG. 15 is obtained for a change in brightness, the change in brightness does not appear as a flicker to a human eye, but when a waveform as shown in FIG. 17 is obtained for a change in brightness, the change in brightness appears as a flicker to a human eye.

Two factors are conceivable as factors for occurrence of a difference between the value of the optimum common electrode voltage in the odd column and the value of the optimum common electrode voltage in the even column.

First factor: occurrence of uneven distribution of charges (charges accumulated in a pixel capacitance between a pixel electrode and the common electrode) between an odd column and an even column at the time of switching of the driving frequency.

Second factor: occurrence of a difference, between an odd column and an even column, in a level of a pull-in voltage occurring at the time of a scanning signal voltage falling from a gate-on voltage to a gate-off voltage.

The first factor will be described with reference to FIG. 18. In FIG. 18, a change in the video signal voltage is indicated by a solid line and a change in an effective voltage taking accumulation of charges into account is indicated by a thick dotted line, for each of an odd column SO and an even column SE. A change in brightness is indicated by a thick solid line. The waveform of the change in brightness schematically shows the change in brightness, and does not show an accurate change in brightness. A period indicated by an arrow denoted by a reference sign FR(o) is an odd frame, and a period indicated by an arrow denoted by a reference sign FR(e) is an even frame. It should be noted that a period before a time point t92 is a pause period during which the driving frequency is 1 Hz, and a period after the time point t92 is a normal period during which the driving frequency is 30 Hz. That is, a length of each frame period (FR(o), FR(e)) in the period before the time point t92 (pause period) is one second, and a length of each frame period (FR(o), FR(e)) in the period after the time point t92 (normal period) is 1/30 seconds. In this manner, in the example shown in FIG. 18, the driving frequency is switched at the time point t92. It should be noted that, in FIG. 18, a level of the liquid crystal applied voltage is schematically shown by hatching.

In the pause period, the polarity of the liquid crystal applied voltage in the odd column SO is positive, and the polarity of the liquid crystal applied voltage in the even column SE is negative. Accordingly, when taking a time point t90 as a reference, in a period up to a time point t91, charges are accumulated, in the odd column SO, in the pixel capacitance in such a way that the optimum common electrode voltage shifts to a positive side, and charges are accumulated, in the even column SE, in the pixel capacitance in such a way that the optimum common electrode voltage shifts to a negative side. As a result, at the time point t91, the effective voltage in the odd column SO is higher than the original liquid crystal applied voltage by ΔVa, and the effective voltage in the even column SE is higher than the original liquid crystal applied voltage by ΔVb, as shown in FIG. 18. As can be seen from FIG. 18, due to charges being accumulated in the pixel capacitance in the above manner, in the even frame FR(e), the liquid crystal applied voltage becomes lower than an original voltage in both the odd column SO and the even column SE, and thus, the brightness becomes lower than original brightness, and in the odd frame FR(o), the liquid crystal applied voltage becomes higher than the original voltage in both the odd column SO and the even column SE, and thus, the brightness becomes higher than original brightness.

At a time point immediately before the time point t92, charges are accumulated, in the odd column SO, in the pixel capacitance in such a way that the optimum common electrode voltage shifts to a positive side, and charges are accumulated, in the even column SE, in the pixel capacitance in such a way that the optimum common electrode voltage shifts to a negative side. Accordingly, in the normal period after switching of the driving frequency at the time point t92, a state where the optimum common electrode voltage is shifted to the positive side is maintained in the odd column SO, and a state where the optimum common electrode voltage is shifted to the negative side is maintained in the even column SE. Accordingly, in the normal period, in the odd frame FR(o), the liquid crystal applied voltage is lower than the original voltage in both the odd column SO and the even column SE, and thus, the brightness is lower than the original brightness, and in the even frame FR(e), the liquid crystal applied voltage is higher than the original voltage in both the odd column SO and the even column SE, and thus, the brightness is higher than original brightness, as can be seen from FIG. 18. Here, since the driving frequency in the normal period is 30 Hz, there is generation of a change in brightness at a frequency of 15 Hz. A flicker is thus caused.

As described above, in a conventional liquid crystal display device employing low-frequency driving, a flicker is caused due to a difference in the optimum common electrode voltage between the odd column and the even column, for example. Japanese Laid-Open Patent Publication No. 2009-92930 discloses a technique for suppressing occurrence of such a flicker. A liquid crystal display device disclosed in Japanese Laid-Open Patent Publication No. 2009-92930 employs a configuration where, with respect to a positional relationship between a common electrode and a pixel electrode, an S-TOP pixel configuration and a C-TOP pixel configuration alternately appear on a per-column basis, where the S-TOP pixel configuration takes a lower layer electrode as the common electrode and the C-TOP pixel configuration takes an upper layer electrode as the common electrode, and such a configuration enables a common voltage at the part of the S-TOP pixel configuration and a common voltage at the part of the C-TOP pixel configuration to be separately adjusted. Occurrence of a flicker is suppressed by separately adjusting the common voltages at two parts.

However, in the liquid crystal display device disclosed in Japanese Laid-Open Patent Publication No. 2009-92930, the pixel configuration is different in the odd column and the even column, for example. Accordingly, even if a video signal voltage of a same level is applied to the odd column and the even column, a shifting direction of the optimum common electrode voltage is different between the odd column and the even column. Accordingly, even if a flicker is not caused when light is initially turned on, a frequency component at half the driving frequency becomes larger as time elapses from turning on of light, with respect to a change in brightness, and a flicker is caused. Moreover, Japanese Laid-Open Patent Publication No. 2009-92930 does not describe a shift (change) in the optimum common electrode voltage accompanying switching of the driving frequency (switching between the normal period and the pause period).

### SUMMARY OF THE INVENTION

Accordingly, realization of a liquid crystal display device which is capable of preventing occurrence of a flicker which is caused due to low-frequency driving is anticipated.

A liquid crystal display device according to some embodiments is a liquid crystal display device including a plurality of pixel electrodes that are arranged in a matrix, the liquid crystal display device including a first common electrode provided in correspondence with a pixel electrode to which a positive video signal is applied in a certain frame period, a second common electrode provided in correspondence with a pixel electrode to which a negative video signal is applied in the certain frame period, and a common electrode driving unit configured to be capable of separately applying a voltage to the first common electrode and the second common electrode, where the plurality of pixel electrodes are formed on a same layer, and the first common electrode and the second common electrode are formed on a same layer.

According to such a configuration, unlike in a normal case, the common electrodes are divided into the first common electrode corresponding to the pixel electrode to which a positive video signal is applied in a certain frame period, and the second common electrode corresponding to the pixel electrode to which a negative video signal is applied in the certain frame period. The common electrode driving unit is configured to be capable of separately applying a voltage to the first common electrode and the second common electrode. Accordingly, even if an optimum common electrode voltage for the first common electrode and an optimum common electrode voltage for the second common electrode take different values due to low-frequency driving, a suitable voltage can be applied, as the common voltage, to each of the first common electrode and the second common electrode, and occurrence of a flicker can be prevented. A liquid crystal display device which is capable of preventing occurrence of a flicker which is caused by low-frequency driving is thereby realized.

These and other objects, features, modes, and advantageous effects of the present invention will be made further apparent from the appended drawings and the detailed description of the present invention given below.

### BRIEF DESCRIPTION OF THE DRAWINGS

FIG. 1 is a diagram showing a configuration of main parts of a first embodiment.

FIG. 2 is a block diagram showing an overall configuration of a liquid crystal display device according to the first embodiment.

FIG. 3 is a diagram showing a configuration of common electrodes corresponding to apart of a pixel matrix, according to the first embodiment (an example where a stripe arrangement is employed).

FIG. 4 is a diagram showing a configuration of common electrodes corresponding to apart of a pixel matrix, according to the first embodiment (an example where a staggered arrangement is employed).

FIG. 5 is a diagram showing an example of a positional relationship between a common electrode and a pixel electrode, according to the first embodiment (an example where a lower layer electrode is the common electrode).

FIG. 6 is a diagram showing an example of a positional relationship between a common electrode and a pixel electrode, according to the first embodiment (an example where an upper layer electrode is the common electrode).

FIG. 7 is a diagram for describing generation of a 15 Hz component (frequency component at half a driving frequency) where image display at a gradation value 128 is performed by a liquid crystal display device capable of gradation display with 256 gradations, with a driving frequency at 30 Hz.

FIG. 8 is a diagram showing differences in a brightness waveform based on values of three ΔVcom (−7.0 mV, −1.0 mV, and +7.0 mV).

FIG. 9 is a diagram showing a change in an effective voltage where a direct voltage of +2V is continuously applied to liquid crystal for 10 seconds in a liquid crystal display device.

FIG. 10 is a diagram for describing a driving method according to a second embodiment (a case where a length of a last frame in a pause period is one second).

FIG. 11 is a diagram for describing a driving method according to the second embodiment (a case where the length of the last frame in the pause period is less than one second).

FIG. 12 is a diagram showing a change in brightness where a driving frequency is changed in an order of “30 Hz, 1 Hz, 30 Hz” in a case where a common voltage the same as that in a conventional case is applied to a common electrode.

FIG. 13 is a diagram showing a change in brightness where the driving frequency is changed in the order of “30 Hz, 1 Hz, 30 Hz”, according to the second embodiment.

FIG. 14 is a signal waveform diagram, related to a conventional example, for describing a state where ideal display is performed.

FIG. 15 is a waveform diagram, related to the conventional example, showing a change in brightness where ideal display is performed.

FIG. 16 is a signal waveform diagram, related to the conventional example, for describing a state where a flicker is caused.

FIG. 17 is a waveform diagram, related to the conventional example, showing a change in brightness at a time when a flicker is caused.

FIG. 18 is a diagram, related to the conventional example, for describing a first factor for occurrence of a difference between an optimum common electrode voltage in an odd column and the optimum common electrode voltage in an even column.

### DETAILED DESCRIPTION OF PREFERRED EMBODIMENTS

Hereinafter, embodiments will be described with reference to the drawings.

### 1. First Embodiment

### 1.1 Overall Configuration and Outline of Operation

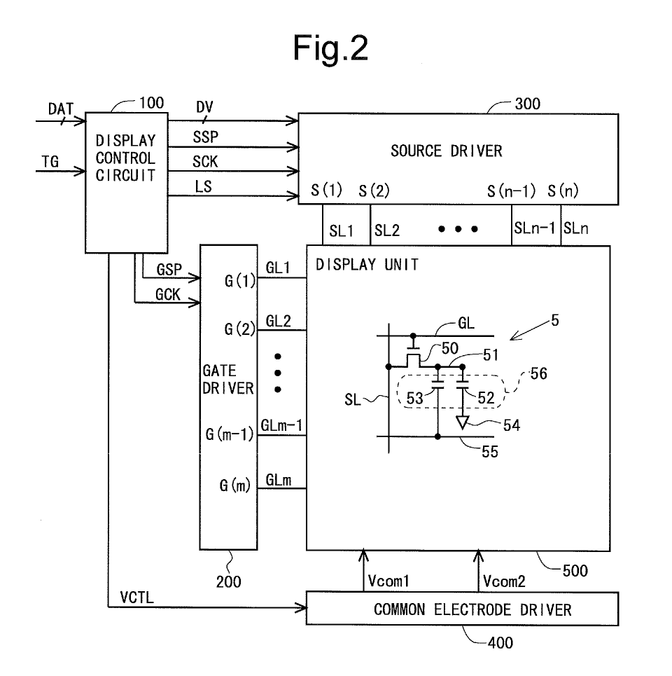

FIG. 2 is a block diagram showing an overall configuration of a liquid crystal display device according to a first embodiment. The liquid crystal display device includes a display control circuit 100, a gate driver 200, a source driver 300, a common electrode driver (common electrode driving unit) 400, and a display unit 500.

A plurality (n) of source bus lines (video signal lines) SL1, . . . , SLn, and a plurality (m) of gate bus lines (scanning signal lines) GL1, . . . , GLm are disposed in the display unit 500. A pixel formation portion 5 forming a pixel is provided in correspondence with each intersection point of the source bus lines SL1, . . . , SLn and the gate bus lines GL1, . . . , GLm. That is, a plurality (m×n) of pixel formation portions 5 are included in the display unit 500. The plurality of pixel formation portions 5 are arranged in a matrix, and configure a pixel matrix. Each pixel formation portion 5 includes a thin-film transistor (TFT) 50, which is a switching element having a gate electrode connected to the gate bus line GL passing through a corresponding intersection point and a source electrode connected to the source bus line SL passing through the intersection point, a pixel electrode 51 connected to a drain electrode of the TFT 50, a common electrode 54 and an auxiliary capacitance electrode 55 provided in common to the plurality of pixel formation portions 5, a liquid crystal capacitance 52 formed by the pixel electrode 51 and the common electrode 54, and an auxiliary capacitance 53 formed by the pixel electrode 51 and the auxiliary capacitance electrode 55. The liquid crystal capacitance 52 and the auxiliary capacitance 53 form a pixel capacitance 56. It should be noted that structural elements corresponding to only one pixel formation portion 5 are shown in the display unit 500 in FIG. 2.

Although a detailed description will be given later, in the present embodiment, the common electrode 54 is divided into a part for an odd column and a part for an even column. In the following, the common electrode for the odd column will be denoted by a reference sign 54(o), and the common electrode for the even column will be denoted by a reference sign 54(e).

As the TFT 50 in the display unit 500, an oxide TFT (a thin-film transistor using an oxide semiconductor as a channel layer) may be used, for example. More specifically, a TFT, a channel layer of which is formed of indium-gallium-zinc-oxide (In—Ga—Zn—O), which is an oxide semiconductor using indium (In), gallium (Ga), zinc (Zn), and oxygen (O) as main components (hereinafter such a TFT will be referred to as “In—Ga—Zn—O-TFT”) may be used as the TFT 50. By using such an In—Ga—Zn—O-TFT, effects such as increased resolution and reduced power consumption can be achieved. Furthermore, because a leakage current at the TFT 50 is reduced, occurrence of a flicker can be effectively suppressed. A transistor using an oxide semiconductor other than indium-gallium-zinc-oxide (In—Ga—Zn—O) as the channel layer may also be used as the TFT 50 in the display unit 500. For example, the same effect can be obtained also in the case of using a transistor which uses, as the channel layer, an oxide semiconductor containing at least one of indium, gallium, zinc, copper (Cu), silicon (Si), tin (Sn), aluminum (Al), calcium(Ca), germanium (Ge), and lead (Pb). It should be noted that use of TFTs other than the oxide TFT is not excluded.

Next, operation of the structural elements shown in FIG. 2 will be described. The display control circuit 100 receives an image signal DAT, and a timing signal group TG such as a horizontal synchronization signal and a vertical synchronization signal, which are transmitted from outside, and outputs a digital video signal DV, a gate start pulse signal GSP and a gate clock signal GCK for controlling operation of the gate driver 200, a source start pulse signal SSP, a source clock signal SCK and a latch strobe signal LS for controlling operation of the source driver 300, and a common voltage control signal VCTL for controlling operation of the common electrode driver 400.

The gate driver 200 repeats application of an active scanning signal G(1), . . . , G(m) to each gate bus line GL1, . . . ,

GLm in every one vertical scanning period as a cycle, based on the gate start pulse signal GSP and the gate clock signal GCK transmitted from the display control circuit 100.

The source driver 300 receives the digital video signal DV, the source start pulse signal SSP, the source clock signal SCK, and the latch strobe signal LS, which are transmitted from the display control circuit 100, and applies driving video signals S(1), . . . , S(n) to the source bus lines SL1, . . . , SLn. At this time, the digital video signal DV indicating a voltage to be applied to each source bus line SL1, . . . , SLn is sequentially held in the source driver 300 at a timing of generation of a pulse of the source clock signal SCK. Then, the held digital video signal DV is converted into an analog voltage at a timing of generation of a pulse of the latch strobe signal LS. Analog voltages obtained by such conversion are simultaneously applied to all the source bus lines SL1, . . . , SLn as the driving video signals S(1), . . . , S(n).

The common electrode driver 400 applies a common voltage Vcom1 to the common electrode 54(o) and applies a common voltage Vcom2 to the common electrode 54(e), based on the common voltage control signal VCTL transmitted from the display control circuit 100. That is, the common electrode driver 400 is capable of separately applying a voltage to the common electrode 54(o) for the odd column and common electrode 54(e) for the even column.

In this manner, the scanning signals G(1), . . . , G(m) are applied to the gate bus lines GL1, . . . , GLm, the driving video signals S(1), . . . , S(n) are applied to the source bus lines SL1, . . . , SLn, the common voltage Vcom1 is applied to the common electrode 54(o), and the common voltage Vcom2 is applied to the common electrode 54(e), and an image depending on the image signal DAT, which is transmitted from outside, is thereby displayed on the display unit 500.

### 1.2 Configuration and Driving Method of Common Electrode

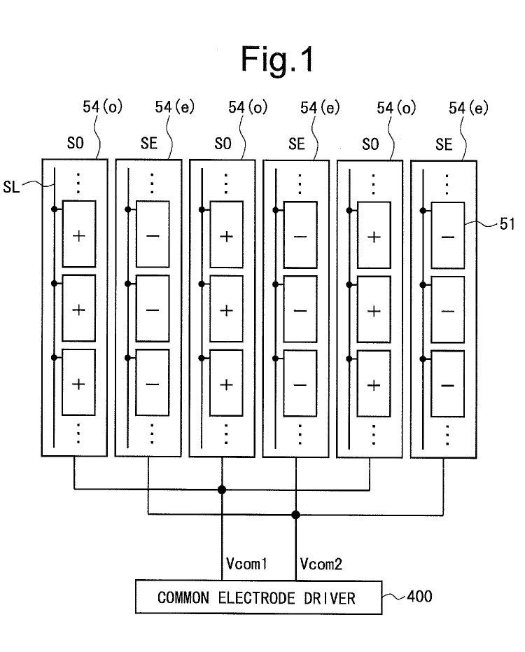

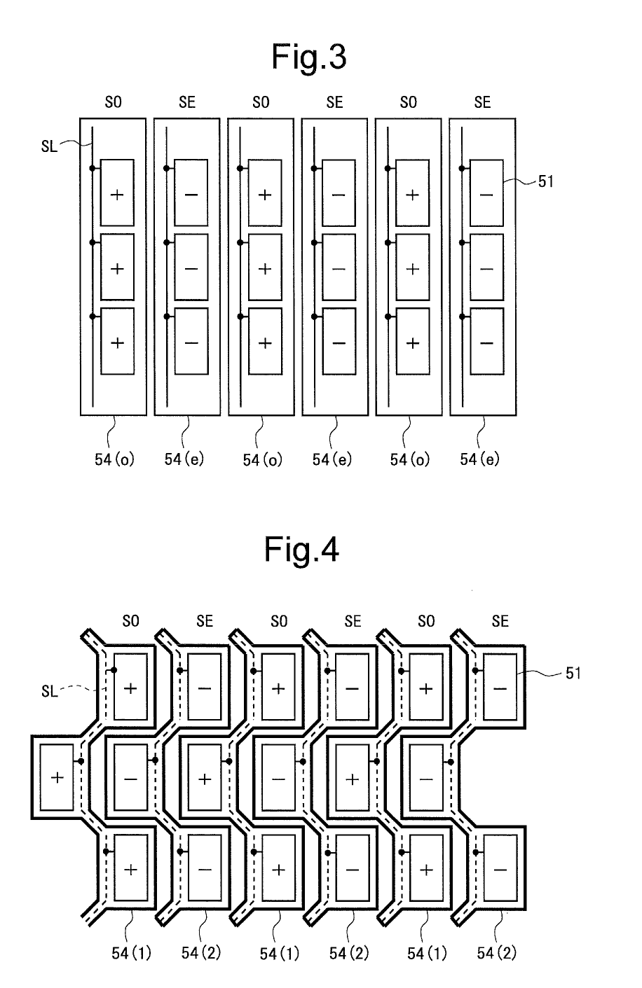

Next, a configuration of the common electrode 54 according to the present embodiment will be described. FIG. 3 is a diagram showing a configuration of the common electrodes 54 corresponding to a part of a pixel matrix. In FIG. 3, polarity of the liquid crystal applied voltage in a certain frame period (that is, polarity of a video signal that is applied to the pixel electrode 51 in the certain frame period) is shown at a part indicating the pixel electrode 51. As can be seen from FIG. 3, in the certain frame period, the liquid crystal applied voltage in an odd column SO is positive, and the liquid crystal applied voltage in an even column SE is negative. That is, with respect to polarity reversal, the liquid crystal display device performs column-reversal driving. Under such a premise, in the present embodiment, the common electrodes 54 are provided in a manner in which the common electrodes 54 are divided into the common electrodes 54(o) for the odd columns and the common electrodes 54(e) for the even columns. In other words, the common electrodes 54 are provided in a manner in which the common electrodes 54 are divided into the common electrodes 54(o) corresponding to the pixel electrodes 51 to which a positive video signal is applied in a certain frame period, and the common electrodes 54(e) corresponding to the pixel electrodes 51 to which a negative video signal is applied in the certain frame period. Then, as described above, the common electrode driver 400 applies the common voltage Vcom1 to the common electrodes 54(o), and applies the common voltage Vcom2 to the common electrodes 54(e) (see FIG. 1). That is, a voltage can be separately applied to the common electrodes 54(o) for the odd columns, and the common electrodes 54(e) for the even columns.

It should be noted that an example is described where column-reversal driving is performed with respect to polarity reversal, but this is not restrictive. For example, the present invention is also applicable to a case where dot-reversal driving is performed in a pseudo manner by making a positional relationship of the source bus lines SL and the pixel electrodes 51 a staggered arrangement as shown in FIG. 4. In FIG. 4, the common electrode 54 is indicated by a thick line, and the source bus line SL is indicated by a dotted line. Also in the example shown in FIG. 4, the common electrodes 54 are provided in a manner in which the common electrodes 54 are divided into common electrodes 54(1) corresponding to the pixel electrodes 51 to which a positive video signal is applied in a certain frame period, and common electrodes 54(2) corresponding to the pixel electrodes 51 to which a negative video signal is applied in the certain frame period. The driving method regarding polarity reversal is not particularly limited as long as a voltage can be separately applied, in the above manner, to the common electrode 54 corresponding to the pixel electrode 51 to which a positive video signal is applied in a certain frame period, and the common electrode 54 corresponding to the pixel electrode 51 to which a negative video signal is applied in the certain frame period.

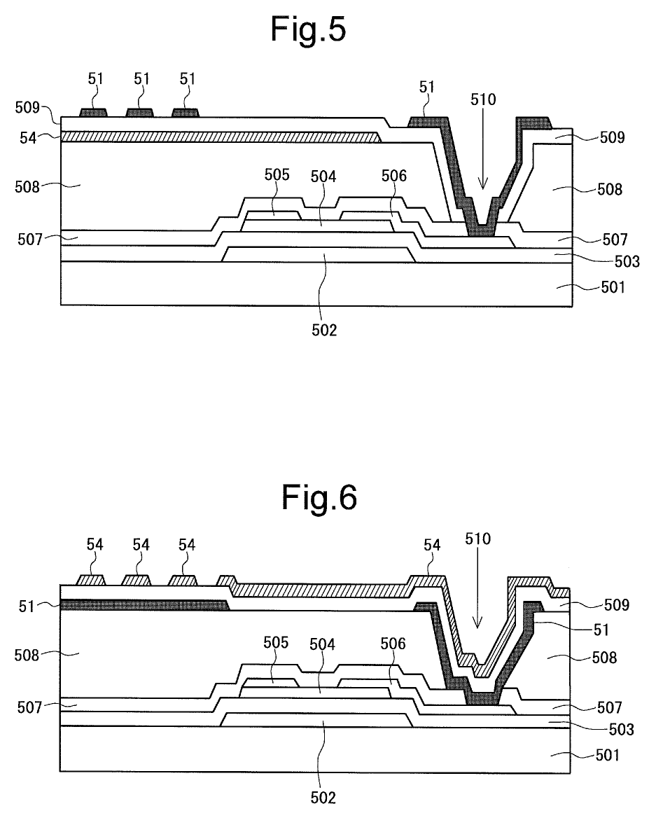

In the present embodiment, the common electrode 54(o) for the odd column and the common electrode 54(e) for the even column are formed on the same layer. That is, the common electrode 54 corresponding to the pixel electrode 51 to which a positive video electrode is applied in a certain frame period, and the common electrode 54 corresponding to the pixel electrode 51 to which a negative video signal is applied in the certain frame period are formed on the same layer. Furthermore, all the pixel electrodes 51 in the display unit 500 are formed on the same layer. With respect to this point, while the configuration of the pixel formation portion 5 is dependent on an operation mode of the liquid crystal (VA mode, TN mode, IPS mode, FFS mode, etc.), no particular restrictions are imposed on an operation mode of the liquid crystal as long as the common electrodes 54 can be divided in the manner described above. Furthermore, in the case of employing the FFS mode, for example, with respect to a positional relationship between the common electrode 54 and the pixel electrode 51, a configuration, as shown in FIG. 5, according to which “a lower layer electrode is the common electrode 54, and an upper layer electrode is the pixel electrode 51” can be employed, or a configuration, as shown in FIG. 6, according to which “an upper layer electrode is the common electrode 54, and a lower layer electrode is the pixel electrode 51” may be employed.

The configuration shown in FIG. 5 will be described. As shown in FIG. 5, a gate electrode 502 is formed on a glass substrate 501, and a gate insulating film 503 is formed to cover the gate electrode 502. An insular semiconductor layer (channel layer) 504 is formed on the gate insulating film 503, and a source electrode 505 and a drain electrode 506 are formed on an upper surface of the semiconductor layer 504, with a predetermined distance therebetween. A passivation film 507 is formed to cover the semiconductor layer 504, the source electrode 505, and the drain electrode 506, and an organic insulating film 508 is formed on the passivation film 507. The common electrode 54 is formed on an upper surface of the organic insulating film 508, and a passivation film 509 is formed to cover the common electrode 54. The pixel electrodes 51 are formed on the passivation film 509. The drain electrode 506 and the pixel electrode 51 are directly connected at a part where a contact hole 510 is formed.

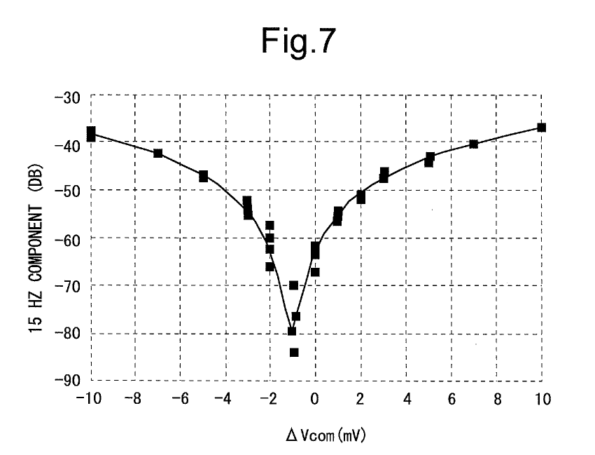

Next, a driving method of the common electrode 54 according to the present embodiment will be described. FIG. 7 is a diagram for describing generation of a 15 Hz component (frequency component at half a driving frequency) where image display at a gradation value 128 is performed by a liquid crystal display device capable of gradation display with 256 gradations, with a driving frequency at 30 Hz. In FIG. 7, values of the 15 Hz component for various ΔVcom, where a difference between the common voltage Vcom1 and the common voltage Vcom2 (Vcom1−Vcom2) is expressed as ΔVcom, are shown. The value of the 15 Hz component is a flicker value where a flicker is measured by JEITA (Japan Electronics and Information Technology industries Association) method.

It can be grasped from FIG. 7 that the value of the 15 Hz component (i.e., flicker value) is the smallest when ΔVcom is −1 mV. That is, the flicker is smaller “when the value of the common voltage Vcom2 is greater than the value of the common voltage Vcoml by 1 mV” than “when the value of the common voltage Vcom1 and the value of the common voltage Vcom2 are the same”. Accordingly, the flicker can be minimized by separately adjusting the value of the common voltage Vcoml and the value of the common voltage Vcom2. Therefore, as described above, in the present embodiment, a configuration according to which a voltage can be separately applied to the common electrode 54(o) for the odd column and the common electrode 54(e) for the even column is employed.

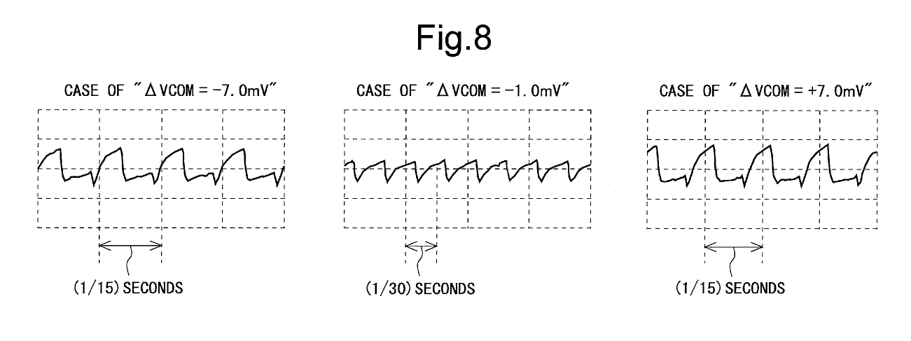

FIG. 8 is a diagram showing differences in a brightness waveform based on values of three ΔVcom (−7.0 mV, −1.0 mV, and +7.0 mV). As shown in FIG. 8, when ΔVcom is −7.0 mV, and when ΔVcom is +7.0 mV, brightness is changed in a cycle of 1/15 seconds. As described above, a change in brightness at a frequency of 5 Hz to 15 Hz tends to be recognized as a flicker by a human eye, and thus, a flicker is noticeably recognized when ΔVcom is −7.0 mV and when ΔVcom is +7.0 mV. In contrast, when ΔVcom is −1.0 mV, brightness is changed in a cycle of 1/30 seconds. That is, there is a change in brightness at a frequency of 30 Hz, which is the driving frequency. Accordingly, the flicker which is recognized by a human eye is the smallest.

In view of the above, in the present embodiment, the common electrode driver 400 separately applies a voltage to the common electrode 54(o) for the odd column and the common electrode 54(e) for the even column. Specifically, the common electrode driver 400 applies the optimum common electrode voltage for the odd column as the common voltage Vcoml to the common electrode 54(o) for the odd column, and applies the optimum common electrode voltage for the even column as the common voltage Vcom2 to the common electrode 54(e) for the even column.

### 1.3 Effects

According to the present embodiment, in the liquid crystal display device employing the column-reversal driving, the common electrodes 54 are provided in a manner in which the common electrodes 54 are divided into the common electrode 54(o) for the odd column and the common electrode 54(e) for the even column. The common electrode driver 400 is configured to be capable of separately applying a voltage to the common electrode 54(o) for the odd column and the common electrode 54(e) for the even column. Accordingly, even when a difference is caused between the odd column and the even column with respect to the value of the optimum common electrode voltage due to low-frequency driving, the common electrode driver 400 can apply the optimum common electrode voltage for the odd column as the common voltage Vcoml to the common electrode 54(o) for the odd column, and apply the optimum common electrode voltage for the even column as the common voltage Vcom2 to the common electrode 54(e) for the even column, and occurrence of a flicker can thereby be prevented. As described above, according to the present embodiment, a liquid crystal display device which is capable of preventing occurrence of a flicker which is caused by low-frequency driving is realized.

### 2. Second Embodiment

### 2.1 Outline

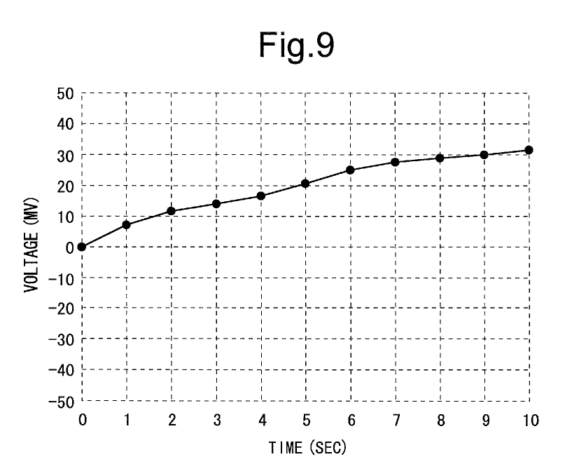

FIG. 9 is a diagram showing a change in an effective voltage where a direct voltage of +2V is continuously applied to liquid crystal for 10 seconds in a liquid crystal display device. As shown in FIG. 9, the effective voltage is increased over time. When a driving frequency is reduced, a period during which a direct voltage is applied to the liquid crystal is increased. Accordingly, it can be grasped from FIG. 9 that a change in the effective voltage is increased as the driving frequency becomes lower. In low-frequency driving during which switching between a pause period and a normal period is performed as described above, the effective voltage is greatly changed during the pause period. When the effective voltage is changed in this way, the optimum common electrode voltage is also changed.

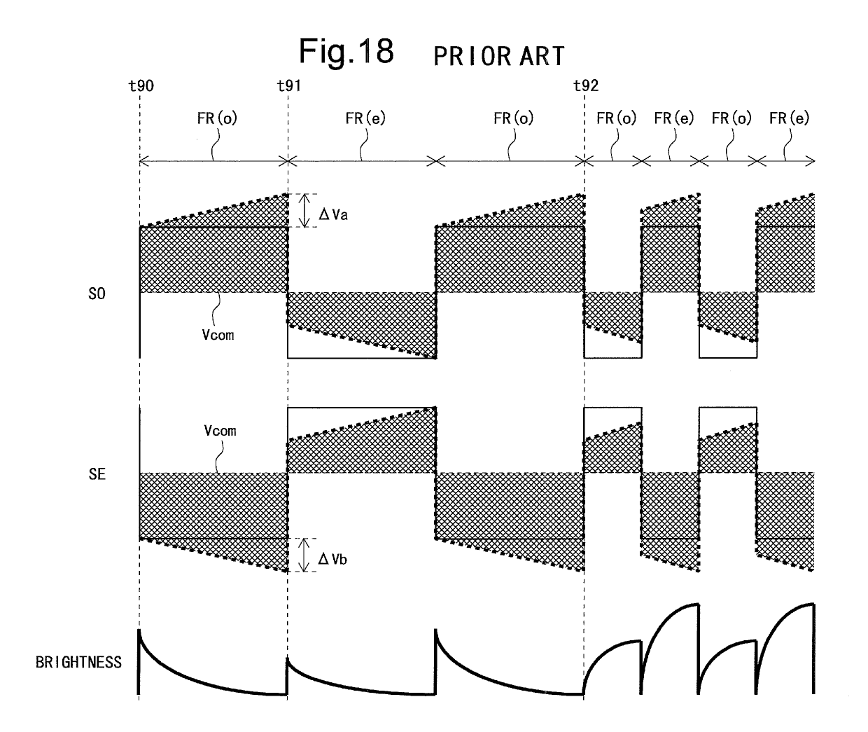

Incidentally, in a case where the column-reversal driving is employed, a shifting direction of the optimum common electrode voltage when the common voltage Vcom is taken as the reference is different between the odd column SO and the even column SE, as can be grasped from FIG. 18. The reason is that uneven distribution of charges (charges accumulated in a pixel capacitance between the pixel electrode and the common electrode) is caused between the odd column SO and the even column SE depending on the timing of switching of the pause period to the normal period. When such uneven distribution of charges is caused at the time of switching from the pause period to the normal period, a frequency component at half the driving frequency is generated, in the normal period, with respect to a change in brightness. The change in brightness is recognized as a flicker by a human eye.

Accordingly, in the present embodiment, in a liquid crystal display device employing the column-reversal driving, the common electrode driver 400 separately applies a voltage of a triangular-wave to the common electrode 54(o) for the odd column and the common electrode 54(e) for the even column in such a way that a difference between brightness in the odd frame and brightness in the even frame becomes small. It should be noted that an overall configuration of the liquid crystal display device and a configuration of the common electrode 54 are the same as those in the first embodiment, and thus, a description will be given below for aspects different from the first embodiment.

### 2.2 Driving Method of Common Electrode

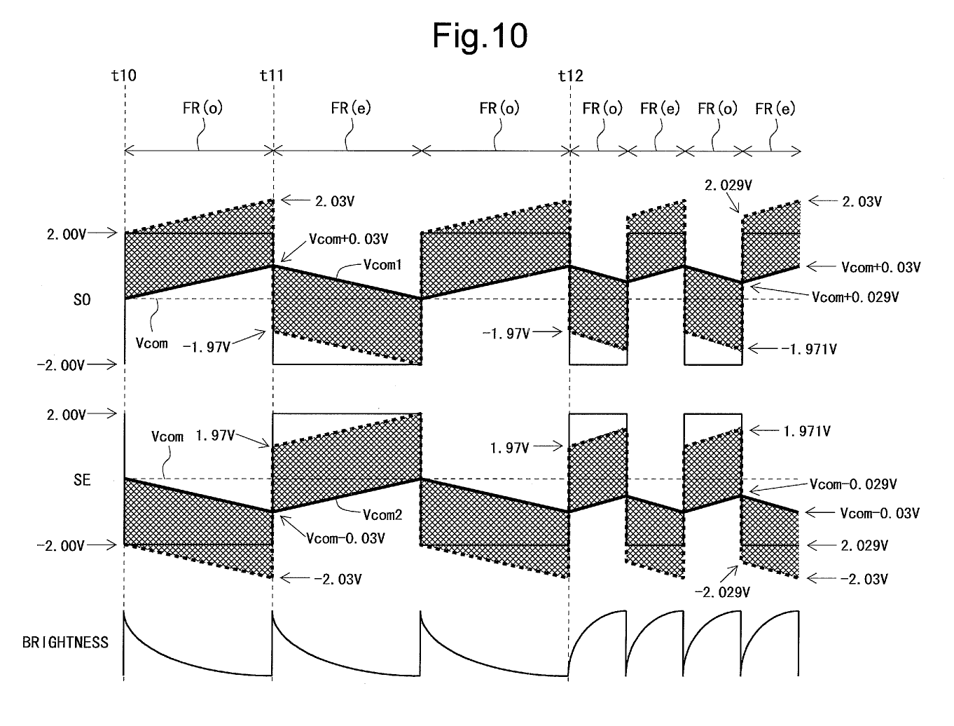

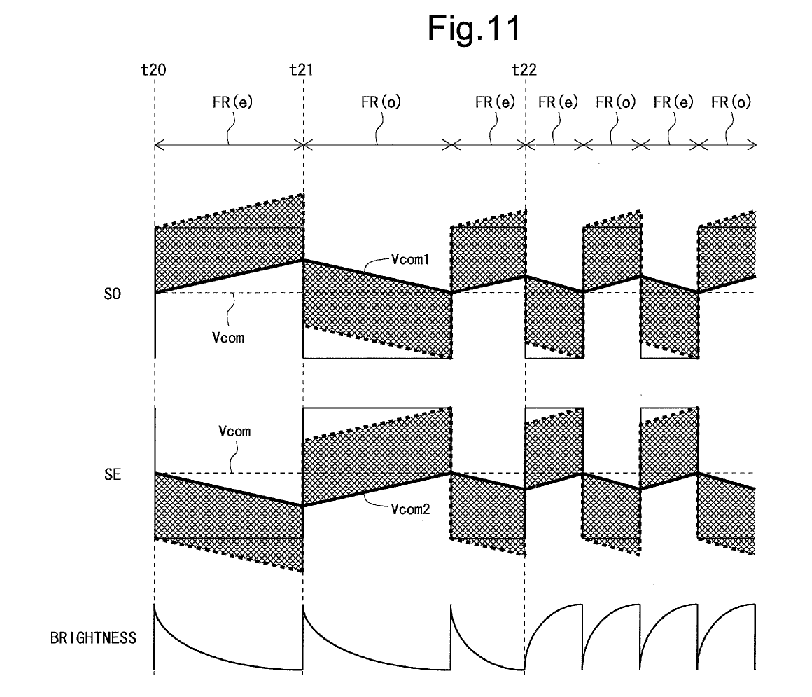

FIGS. 10 and 11 are diagrams for describing a driving method according to the present embodiment. FIG. 10 shows a waveform where a length of a last frame in the pause period is one second, and FIG. 11 shows a waveform where the length of the last frame in the pause period is less than one second. In FIGS. 10 and 11, with respect to each of the odd column SO and the even column SE, a change in a video signal voltage is indicated by a thin solid line, a change in an effective voltage taking accumulation of charges into account is indicated by a thick dotted line, a change in a voltage (common voltage Vcom1, Vcom2) applied to the common electrode 54 (common electrode 54(o) for odd column, common electrode 54(e) for even column) is indicated by a thick solid line, and a common voltage Vcom for a case where the driving method according to the present embodiment is not employed is indicated by a thin dotted line. In FIG. 10, a time point t12 is a timing of switching from the pause period to the normal period, and in FIG. 11, a time point t22 is a timing of switching from the pause period to the normal period. Driving in the pause period corresponds to first driving, and driving in the normal period corresponds to second driving. It should be noted that FIG. 10 shows examples of a specific value of voltage.

First, a case where a length of a last frame in the pause period is one second will be described (see FIG. 10). When taking a time point t10 as a reference, in a period up to a time point t11, charges are accumulated, in the odd column SO, in the pixel capacitance 56 in such a way that the optimum common electrode voltage shifts to a positive side, and charges are accumulated, in the even column SE, in the pixel capacitance 56 in such away that the optimum common electrode voltage shifts to a negative side. Accordingly, if a common voltage Vcom the same as that in the conventional case is applied to the common electrode 54 (common electrode 54(o) for odd column, common electrode 54(e) for even column), the effective voltage becomes higher than the original liquid crystal applied voltage at the time point t11 in both the odd column SO and the even column SE. Therefore, in the present embodiment, as shown in FIG. 10, the common electrode driver 400 causes the value of the common voltage Vcom1 to change depending on a change in the effective voltage in the odd column SO, and causes the value of the common voltage Vcom2 to change depending on a change in the effective voltage in the even column SE.

With respect to this point, a change in the effective voltage is different depending on display gradation and the like. Accordingly, in reality, an amount of change in the effective voltage per unit time when half-tone display is performed by a target liquid crystal display device is measured, and a slope of the waveform of the common voltage Vcom1, Vcom2 is determined based on the amount of change. For example, in the case where the effective voltage is changed by 30 mV in one second when display is performed in certain half tone, the common electrode driver 400 changes the value of the common voltage Vcom1, Vcom2 in such a way that the slope of the waveform is 30 mV per second in the same direction as the shifting direction of the optimum common electrode voltage. It should be noted that the slope of the waveform is dependent on the material of liquid crystal, the material of an alignment film, and the like, and is thus different for each device.

As described above, the common electrode driver 400 changes the value of the common voltage Vcom1, Vcom2. Thereby, as shown in FIG. 10, in the odd column SO, the value of the common voltage Vcom1 is gradually increased in an odd frame FR(o) in the pause period, and the value of the common voltage Vcom1 is gradually reduced in an even frame FR(e) in the pause period. On the other hand, as shown in FIG. 10, in the even column SE, the value of the common voltage Vcom2 is gradually reduced in the odd frame FR(o) in the pause period, and the value of the common voltage Vcom2 is gradually increased in the even frame FR(e) in the pause period.

At a time point immediately before the time point t12, charges are accumulated, in the odd column SO, in the pixel capacitance 56 in such a way that the optimum common electrode voltage shifts to a positive side, and charges are accumulated, in the even column SE, in the pixel capacitance 56 in such a way that the optimum common electrode voltage shifts to a negative side. Accordingly, at the time pint immediately before the time point t12, the value of the common voltage Vcoml is shifted to the positive side compared to the value of the common voltage Vcom in the conventional case, and the value of the common voltage Vcom2 is shifted to the negative side compared to the value of the common voltage Vcom in the conventional case.

When the driving frequency is switched from 1 Hz to 30 Hz (i.e., when the pause period is switched to the normal period) at the time point t12, in a first frame period (odd frame FR(o)) in the normal period, the common electrode driver 400 gradually reduces the value of the common voltage Vcom1 from the value at the time point immediately before the time point t12, and gradually increases the value of the common voltage Vcom2 from the value at the time point immediately before the time point t12. Then, in a next frame period (even frame FR(e)), the common electrode driver 400 gradually increases the value of the common voltage Vcom1, and gradually reduces the value of the common voltage Vcom2. It should be noted that the slope of the waveform of the common voltage Vcom1, Vcom2 in the normal period is the same as the slope in the pause period.

As described above, as shown in FIG. 10, in the odd column SO, the value of the common voltage Vcom1 is gradually reduced in the odd frame FR(o) in the normal period, and the value of the common voltage Vcom1 is gradually increased in the even frame FR(e) in the normal period. On the other hand, as shown in FIG. 10, in the even column SE, the value of the common voltage Vcom2 is gradually increased in the odd frame FR(o) in the normal period, and the value of the common voltage Vcom2 is gradually reduced in the even frame FR(e) in the normal period.

Next, a case where the length of the last frame in the pause period is less than one second will be described (see FIG. 11). With respect to before the time point t22, the same thing applies as before the time point t12 for the case where the length of the last frame in the pause period is one second (see FIG. 10). The amount of charges accumulated in the pixel capacitance 56 at a time point immediately before the time point t22 is different from the amount of charges accumulated in the pixel capacitance 56 at the time point immediately before the time point t12 for the case where the length of the last frame in the pause period is one second. However, also in this case, when the driving frequency is switched from 1 Hz to 30 Hz (i.e., when the pause period is switched to the normal period) at the time point t22, in a first frame period (odd frame FR(o)) in the normal period, the common electrode driver 400 gradually reduces the value of the common voltage Vcom1 from the value at the time point immediately before the time point t22, and gradually increases the value of the common voltage Vcom2 from the value at the time point immediately before the time point t22. Then, in a next frame period (even frame FR(e)), the common electrode driver 400 gradually increases the value of the common voltage Vcom1, and gradually reduces the value of the common voltage Vcom2. It should be noted that, also in this case, the slope of the waveform of the common voltage Vcom1, Vcom2 in the normal period is the same as the slope in the pause period.

As described above, also in the case where the length of the last frame in the pause period is less than one second, the value of the common voltage Vcom1, Vcom2 changes in the following manner in the normal period. As shown in FIG. 11, in the odd column SO, the value of the common voltage Vcom1 is gradually reduced in the odd frame FR(o), and the value of the common voltage Vcom1 is gradually increased in the even frame FR(e). On the other hand, as shown in FIG. 11, in the even column SE, the value of the common voltage Vcom2 is gradually increased in the odd frame FR(o), and the value of the common voltage Vcom2 is gradually reduced in the even frame FR(e).

In the present embodiment, due to the values of the common voltages Vcom1, Vcom2 changing in the above manner, brightness in the odd frame FR(o) (sum of brightness in the odd column SO and brightness in the even column SE) and brightness in the even frame FR(e) (sum of brightness in the odd column SO and brightness in the even column SE) are approximately the same in both the pause period and the normal period. Accordingly, occurrence of a flicker is prevented.

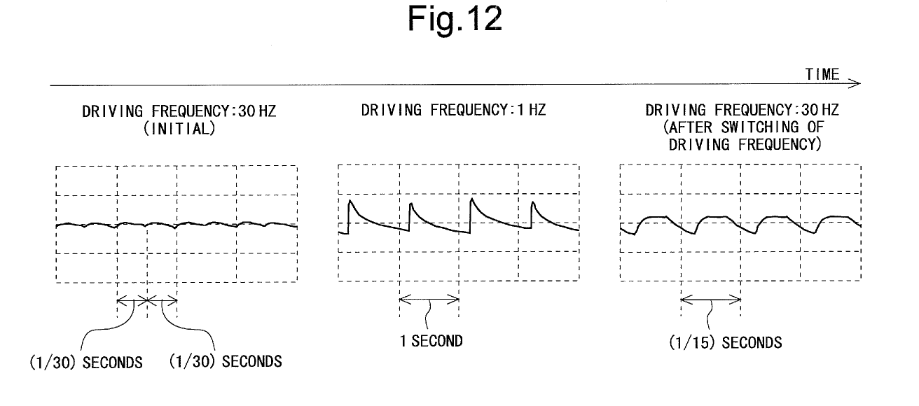

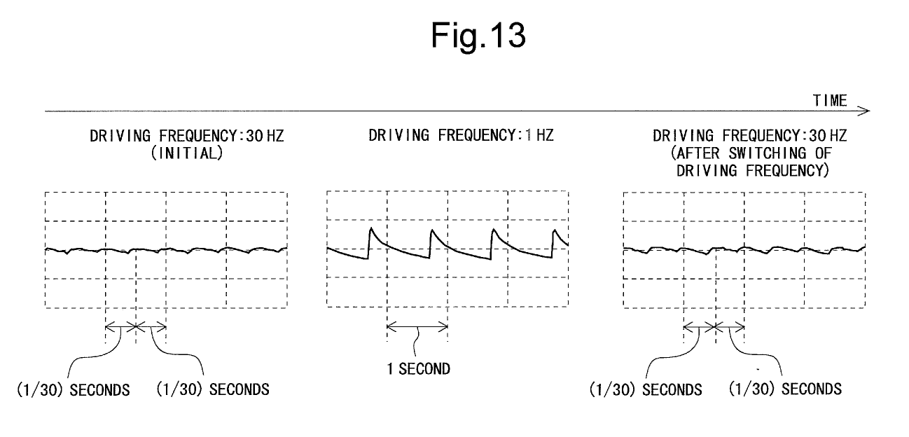

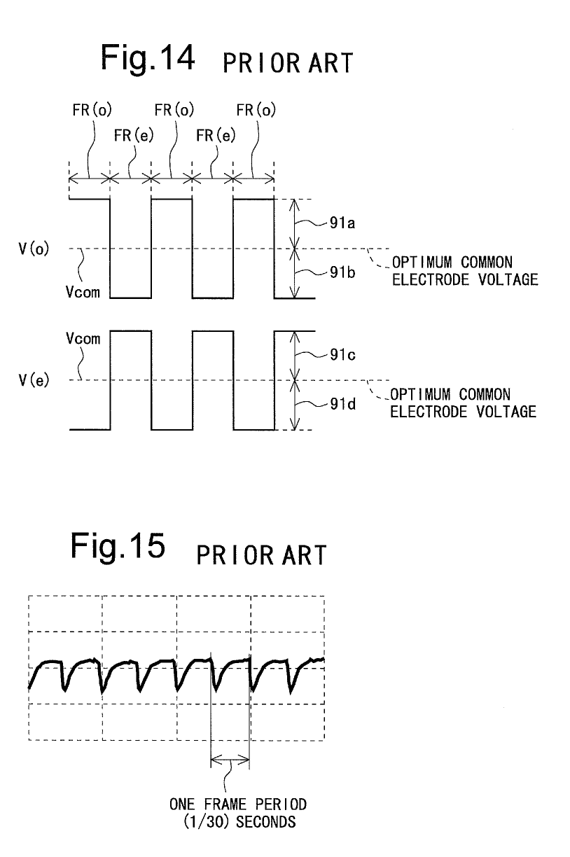

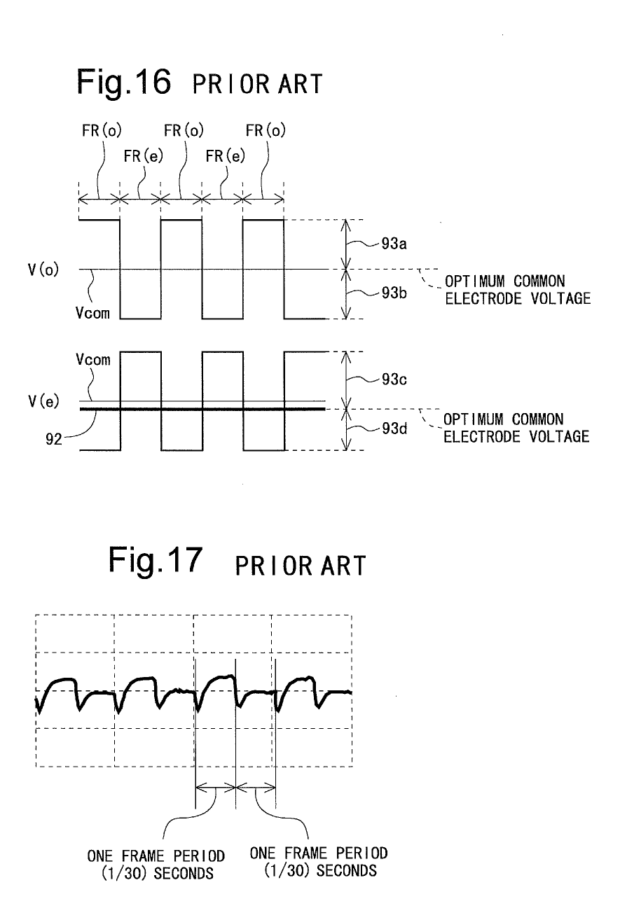

FIG. 12 is a diagram showing a change in brightness where the driving frequency is changed in an order of “30 Hz, 1 Hz, 30 Hz” in a case where the common voltage Vcom the same as that in the conventional case is applied to the common electrode (an example of a case where half-tone display is performed). In this case, a frequency of a change in brightness is 15 Hz after the driving frequency is switched from 1 Hz to 30 Hz. That is, a flicker is noticeably recognized by a human eye. FIG. 13 is a diagram showing a change in brightness where the driving frequency is changed in the order of “30 Hz, 1 Hz, 30 Hz” in the present embodiment (an example of a case where half-tone display is performed). Unlike the example shown in FIG. 12, the frequency of the change in brightness after the driving frequency is switched from 1 Hz to 30 Hz is 30 Hz. Accordingly, a flicker is not recognized by a human eye, and desirable display quality is maintained.

### 2.3 Effects

According to the present embodiment, as in the first embodiment described above, in the liquid crystal display device employing the column-reversal driving, the common electrodes 54 are provided in a manner in which the common electrodes 54 are divided into the common electrode 54(o) for the odd column and the common electrode 54(e) for the even column, and the common electrode driver 400 is configured to be capable of separately applying a voltage to the common electrode 54(o) for the odd column and the common electrode 54(e) for the even column. In such a configuration, the common electrode driver 400 changes the value of the common voltage Vcom1, Vcom2 depending on a change in the effective voltage. More specifically, the common electrode driver 400 applies the triangular-wave common voltage Vcom1 to the common electrode 54(o) for the odd column and applies the triangular-wave common voltage Vcom2 to the common electrode 54(e) for the even column, in such a way that a difference between brightness in the odd frame FR(o) and brightness in the even frame FR(e) becomes small. The frequency of the change in brightness is thereby made 30 Hz, and occurrence of a flicker is effectively prevented. As described above, according to the present embodiment, a liquid crystal display device which is capable of effectively preventing occurrence of a flicker which is caused by low-frequency driving is realized.

### 2.4 Example Modification

In the second embodiment described above, a triangular-wave voltage is applied to the common electrodes 54 (common electrode 54(o) for odd column, common electrode 54(e) for even column) in such a way that a difference between brightness in the odd frame FR(o) and brightness in the even frame FR(e) becomes small. However, the voltage to be applied to the common electrodes 54 (common electrode 54(o) for odd column, common electrode 54(e) for even column) is not limited to the triangular-wave voltage. For example, a sinusoidal voltage or a rectangular-wave voltage may be applied to the common electrodes 54 (common electrode 54(o) for odd column, common electrode 54(e) for even column) so as to reduce the difference between brightness in the odd frame FR(o) and brightness in the even frame FR(e).

The present invention is described above in detail, but the description is illustrative in all aspects and is not restrictive. Numerous other changes and modifications are conceivable without departing from the scope of the present invention.

The present application claims priority from Japanese Patent Application No. 2017-179766 filed on Sep. 20, 2017 and entitled “liquid crystal display device”, the entire contents of which are incorporated herein by reference.

What is claimed is:

1. A liquid crystal display device including a plurality of pixel electrodes that are arranged in a matrix, the liquid crystal display device comprising:
a first common electrode provided in correspondence with a pixel electrode to which a positive video signal is applied in a certain frame period;
a second common electrode provided in correspondence with a pixel electrode to which a negative video signal is applied in the certain frame period; and
a common electrode driving unit configured to be capable of separately applying a voltage to the first common electrode and the second common electrode,
wherein the plurality of pixel electrodes are formed on a same layer, and the first common electrode and the second common electrode are formed on a same layer.

2. The liquid crystal display device according to claim 1, wherein first driving of rewriting a screen in a predetermined cycle and second driving of rewriting the screen in a cycle shorter than the predetermined cycle are performed.

3. The liquid crystal display device according to claim 2, wherein the common electrode driving unit
determines a voltage that is applied to the first common electrode, depending on charges that are accumulated, in a period when the first driving is performed, in a pixel capacitance formed by the pixel electrode corresponding to the first common electrode and the first common electrode, and
determines a voltage that is applied to the second common electrode, depending on charges that are accumulated, in the period when the first driving is performed, in a pixel capacitance formed by the pixel electrode corresponding to the second common electrode and the second common electrode.

4. The liquid crystal display device according to claim 2, wherein the common electrode driving unit applies a voltage of a triangular-wave to the first common electrode and the second common electrode in such a way that a difference between brightness in an odd frame and brightness in an even frame becomes small.

5. The liquid crystal display device according to claim 4, wherein a slope of the triangular-wave is determined on the basis of an amount of change in an effective voltage per unit time when half-tone display is performed.

6. The liquid crystal display device according to claim 2, wherein the common electrode driving unit applies a sinusoidal voltage to the first common electrode and the second common electrode in such a way that a difference between brightness in an odd frame and brightness in an even frame becomes small.
